(19) United States
(12) Patent Application Publication
(10) Pub. No.: US 2007/0287768 A1
(43) Pub. Date: Dec. 13, 2007

(54) Friction material

(75) Inventors: Motoyuki Miyaji, Tokyo (JP); Daisuke Hamagata, Tokyo (JP); Satoshi Kusaka, Tokyo (JP); Shuichi Oshiden, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AKEBONO BRAKE INDUSTRY CO., LTD.

(21) Appl. No.: 11/808,339

(22) Filed: Jun. 8, 2007

(30) Foreign Application Priority Data
Jun. 9, 2006 (JP) P.2006-160963

(51) Int. Cl. C08J 5/14

(52) U.S. Cl. 523/149

(57) ABSTRACT

Anon-asbestos friction material is provided with a fibrous base material, a friction modifier, and a binder, wherein a partially graphitized coke is blended in a ratio of 0.5 vol % to 2.5 vol %. By blending the partially graphitized coke, compression strain of the friction material is adjusted so as to improve brake feeling without deteriorating friction properties.

This application claims foreign priority from Japanese Patent Application No. 2006-160963, filed on Jun. 9, 2006, the entire contents of which are hereby incorporated by reference.

### BACKGROUND OF THE INVENTION

1. Field of the Invention

The present invention relates to a friction material to be used in brakes of automobiles, railway vehicles, industrial machines, and the like and relates to a friction material exhibiting improved heat resistance of little thermal deterioration, wear resistance, and brake feeling, particularly pedal feeling.

2. Related Art

Conventionally, friction materials used for brakes and the like have been manufactured by blending a fibrous base material, a friction modifier, and a binder and carrying out a production process comprising steps of pre-forming, thermal forming, finishing, and the like. As the materials for the friction materials, fibrous base materials such as organic fibers, inorganic fibers including glass fibers, and metal fibers including copper fibers; organic/inorganic friction modifiers such as rubber dust, cashew dust, metal particles, ceramic particles, and graphite; fillers such as calcium carbonate and barium sulfate; and binders such as phenol resins, are used. Among them, when graphite is used as a component of the friction material, owing to lubricity and particularly thermal stability and chemical stability thereof, graphite to be used as a friction modifier plays important roles that not only a stable friction coefficient is obtained in various environments but also wear resistance and burning resistance are excellent and reduction of various noises is secured.

In JP-A-03-282028, it has been confirmed that a material obtained by nitration or sulfonation of a carbon material such as bulk mesophase carbon or raw coke formed in the process of carbonization of pitches and by subsequent graphitization of an expanded product after heat treatment has a low density and excellent in elasticity. The graphite produced thereby has properties that a compressibility ratio at a load of 9000 kg/cm² is 80% or more in volume change based on the volume at a load of 0.1 kg/cm² and a recovery ratio at the time when the load is removed is 50% or more. Thus, a friction material to which the above elastic graphite is added has been investigated.

Moreover, JP-A-05-017739 describes a friction material containing an elastic graphite in a ratio of 3 to 15 wt %. It has been reported that the addition thereof affords a friction material excellent in noise and friction coefficient at fade even when a wear amount of pad of the friction material and a wear amount of a frictional mating member are the same levels as the amounts in the cases of conventional friction materials.

Brake performance of recent passenger cars has been advanced and hence not only silence of no noise and no uncomfortable sound but also good pedal feeling at braking have been required for the brakes. As factors of changing pedal feeling of the brakes, workability thereof and compression deformation of a friction material mainly influence the feeling.

The workability of the brakes can be adjusted mainly by blending materials, but the compression deformation is changed by two factors of materials to be blended and forming conditions. Generally, in the case where the compression deformation is to be adjusted, methods of lowering pressure to be applied in thermal forming and of lowering temperature for forming are employed but these methods may deteriorate strength and wear resistance of the friction material per se in some cases.

When graphite is used as a friction modifier, owing to lubricity and excellent thermal stability and chemical stability thereof, not only a stable friction coefficient is obtained in various environments but also wear resistance and burning resistance are excellent. However, graphite conventionally used has a problem that a friction coefficient is lowered when the amount thereof added is increased. Thus, the use of a highly elastic graphite has been studied but the highly elastic graphite has still not been a sufficiently satisfactory material.

### SUMMARY OF THE INVENTION

One or more embodiments of the invention provide a friction material wherein compression strain is adjusted using a specific highly elastic graphite to improve brake feeling without deteriorating the other properties.

In accordance with one or more embodiments of the invention, a non-asbestos friction material is provided with: a fibrous base material; a friction modifier; a binder; and a partially graphitized coke which is blended in a ratio of 0.5 vol % to 2.5 vol %.

Further, in the non-asbestos friction material, a compressibility ratio of the partially graphitized coke at a load of 900 MPa may be less than 80% and a recovery ratio at the time when the load is removed may be more than 30%.

According to one or more embodiments of the invention, by utilizing a partially graphitized coke having a specific elasticity (elastic coke) as a friction material, porosity and compression strain of the friction material can be adjusted and brake feeling can be optimized without lowering surface pressure for forming and baking temperature.

Other aspects and advantages of the invention will be apparent from the following description and the appended claims.

### BRIEF DESCRIPTION OF THE DRAWINGS

FIG. 1 is a drawing showing results of measuring compression deformation of friction materials of Examples and Comparative Examples.

### DETAILED DESCRIPTION OF THE EXEMPLARY EMBODIMENTS

Exemplary embodiments of the invention will be described.

In the exemplary embodiments of the invention, a part of conventional graphite added to a friction material is replaced with a partially graphitized coke having elasticity, so that compression deformation is increased even when the other materials and forming conditions are not changed.

The “partially graphitized coke having elasticity” is preferably one where graphitization is stopped on the way of graphitizing starting cokes for graphitization to obtain an elastic graphite and a graphitization ratio thereof is from 80 to 95%. As the above starting cokes, there may be mentioned those which are used as production starting materials for elastic graphite, such as carbonaceous mesophases or raw cokes formed during thermal treatment of coal tar pitch, coal-based pitch, petroleum-based pitch, or the like at about 350 to 500° C., or those obtained by treating them with nitric acid or a mixed acid of nitric acid and sulfuric acid.

The graphite usually used in the production of the friction material has properties that a compressibility ratio at a load of 900 MPa is about 70% in volume change on the basis of the time when a load of 0.01 MPa is applied and a recovery ratio at the time when the load is removed is 30% or less. Therefore, it is not sufficient for the purpose of compensating insufficiency of parallelism of a friction surface by elastic deformation of the friction material.

Moreover, JP-A-03-282028 describes an elastic graphite excellent in a compressing property and a recovering property wherein a compressibility ratio at a load of 900 MPa is 80% or more in volume change on the basis of the time when a load of 0.01 MPa is applied and a recovery ratio at the time when the load is removed is 50% or more. However, even in the case of the graphite having such physical properties, the compressibility ratio is still small and hence the object of the invention cannot be achieved.

With regard-to the partially graphitized coke (elastic coke) to be used in the friction material of the exemplary embodiment of the invention, the recovery ratio at the time when a load is removed is extremely high, i.e., from 90% or more to almost 100%. Moreover, the compressibility ratio at a load of 900 MPa is 80% or less, preferably 60% or less. Thus, the coke is anelastic graphite having physical properties different from those of the above conventional graphite. More preferably, an elastic graphite having a recovery ratio of 95% or more and a compressibility ratio within the range of 60% to 40% is used.

A graphitization ratio of the partially graphitized coke (elastic graphite) to be used in the invention measured by X-ray diffraction falls within the range of 80% to 95%. With regard to the amount to be added, a sufficient effect is observed by adding a small amount thereof and it is suitable to blend it in a ratio of 0.5 to 2.5 vol %, preferably 2.0 to 2.5 vol %. Furthermore, in the friction material, the partially graphitized coke is used in combination with conventional graphite (natural graphite, artificial graphite).

The compressibility ratio and recovery ratio of the partially graphitized coke to be used in the exemplary embodiments of the invention are measured by the following method. Namely, about 10 g of a graphite sample is placed in a stainless steel cylindrical mold having an inner diameter of 10 mm. After the mold is patted to attain closest packing, a pushrod is inserted from the upper portion and then a load of 10 Pa is applied. Height of the sample at that time is measured and the value is represented by h₀. Then, a predetermined load is applied and height of the sample is measured, the value being represented by h₁. Thereafter, the load is removed and height of the sample is measured, the value being represented by h₂. From these values, a compressibility ratio and a recovery ratio can be determined according to the following equations.

Compressibility ratio (%)=(h₁/h₀)×100 (1)

Recovery ratio (%)=((h₂−h₁)/h₀)×100 (2)

In the blending of the friction material, those usually used are employed. As the fibrous base material for reinforcement, heat-resistant organic fibers, inorganic fibers, and metal fibers are used. There maybe, for example, mentioned aromatic polyamide fibers and flame-resistant acrylic fibers as the heat-resistant organic fibers; ceramic fibers such as potassium titanate fibers or alumina fibers, glass fibers, and rock wools as the inorganic fibers; and copper fibers and steel fibers as the metal fibers.

As the binder, there may be, for example, mentioned phenol resins (including straight phenol resins and various modified phenol resins with rubber or the like), melamine resins, epoxy resins, polyimide resins, and the like. Moreover, as the friction modifier, there may be, for example, mentioned organic friction modifiers such as rubber dust and cashew dust, abrasives of metal oxides and the like such as alumina, silica, magnesia, zirconia, chromium oxide, and quartz, particles of metals such as copper, aluminum, and zinc, solid lubricants such as graphite and molybdenum disulfide, scale-like inorganic substances such as mica and vermiculite, and inorganic fillers such as barium sulfate and calcium carbonate.

The production of the friction material can be conducted by well-known production processes. For example, the friction material can be produced via steps of pre-forming, thermal forming, heating, grinding, and the like. In the case of a production process of a friction pad for disc brake, there are conducted a step of preparing a pressure plate by forming a predetermined shape by sheet-metal pressing, subjecting it to a degreasing treatment and a primer treatment, and then applying an adhesive; a step of producing a pre-formed product by blending a fibrous base material of a heat-resistant organic fiber, an inorganic fiber, or a metal fiber and powder raw materials such as an inorganic/organic friction modifier, a filler, and a thermosetting resin binder and forming (pre-forming) the raw materials, which have been sufficiently homogenized by stirring, at ordinary temperature under a predetermined pressure; a step of thermal forming of the both members to integrally fix them at a predetermined temperature and pressure; a step of conducting after-cure; and finally a step of conducting a finish treatment. Thus, the friction material can be produced by such a process.

### EXAMPLES

The following will describe the invention in more detail with reference to Examples but the scope of the invention is not limited only to these Examples.

The production process of Examples is as follows.

### 1. Stirring of Blend Materials

In any cases, the blend materials shown in Table 1 were charged into a stirrer all at once, followed by stirring.

TABLE 1

| | | | | | Comparative | Comparative |
|---|---|---|---|---|---|---|
| | | Example 1 | Example 2 | Example 3 | Example 1 | Example 2 |
| Fibrous | Aramide fiber | 10.0 | 10.0 | 10.0 | 10.0 | 10.0 |
| base | Rock wool | 3.0 | 3.0 | 3.0 | 3.0 | 3.0 |
| material | Copper fiber | 4.0 | 4.0 | 4.0 | 4.0 | 4.0 |
| Binder | Phenol resin | 17.0 | 17.0 | 17.0 | 17.0 | 17.0 |
| Friction | Cashew dust | 10.0 | 10.0 | 10.0 | 10.0 | 10.0 |
| modifier | Rubber dust | 10.0 | 10.0 | 10.0 | 10.0 | 10.0 |
| | Barium | 15.5 | 14.5 | 13.5 | 13.0 | 16.0 |
| | sulfate | | | | | |
| | Potassium | 15.0 | 15.0 | 15.0 | 15.0 | 15.0 |
| | titanate | | | | | |
| | Zirconia | 6.0 | 6.0 | 6.0 | 6.0 | 6.0 |
| | Iron oxide | 4.0 | 4.0 | 4.0 | 4.0 | 4.0 |
| | Graphite | 5.0 | 5.0 | 5.0 | 5.0 | 5.0 |
| | Partially | 0.5 | 1.5 | 2.5 | 3.0 | 0.0 |
| | graphitized | | | | | |
| | coke | | | | | |
| Forming | Temperature | 150 | 150 | 150 | 150 | 150 |
| | (° C.) | | | | | |
| | Pressure | 50 | 50 | 50 | 50 | 50 |
| | (MPa) | | | | | |

### 2. Pre-forming and the Like

Each of the above five kinds of stirred products was subjected to steps of pre-forming, thermal forming, heating, grinding, or the like to prepare a friction material as a finished product.

### (1) Pre-Forming

The above stirred product was charged into a mold for a pre-forming press and pressurized at ordinary temperature under a pressure of 40 MPa for 1 minute and thereby pre-formed into a brake pad shape.

### (2) Thermal Forming

The resulting pre-formed product was transferred into a mold for hot pressing in which a pressure plate had been set. After gas-venting was conducted five times at intervals of 10 seconds during heating and pressurization at 150° C. and 50 MPa, thermal forming was conducted at 150° C. and 50 MPa for 4 minutes.

### (3) Heating

After the thermal forming, the product was further heated in a heating furnace at 250° C. for 3 hours to carry out after-cure.

### (4) Grinding

After the after-cure, the product was grinded so as to be a predetermined thickness by means of a plane grinder to obtain a friction material as a finished product (brake pad).

### Examples 1 to 3

A partially graphitized coke having elasticity (RGC 14A from Superior Graphite Co.) was added in a ratio of 0.5 to 2.5 vol %. With the formulation, as mentioned above, after steps of dry stirring, pre-forming, thermal forming (see Table 1 for temperature and pressure), and heating were conducted, grinding was carried out to obtain a finished product.

### Comparative Example 1

The partially graphitized coke having elasticity was added in a ratio of 3.0 vol %. Production conditions are in accordance with Examples 1 to 3.

### Comparative Example 2

The partially graphitized coke having elasticity was not added. Production conditions are in accordance with Examples 1 to 3.

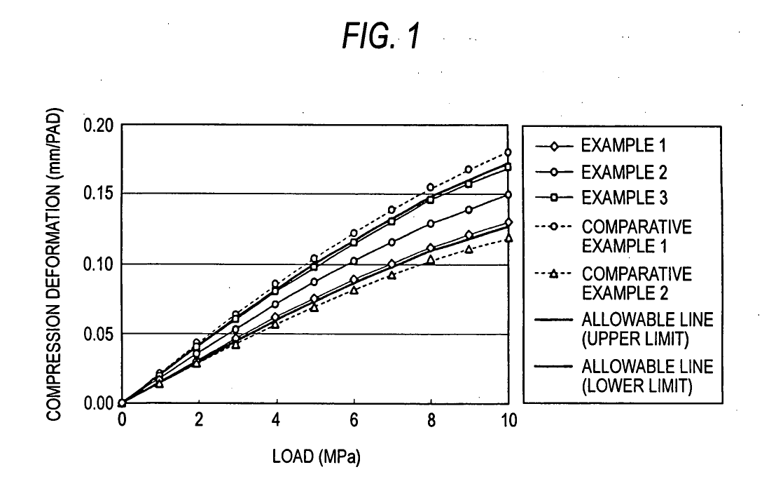

Then, compression deformation was measured on the friction materials of Examples 1 to 3 and Comparative Examples 1 and 2 (thickness of mother material: 2.5 mm, thickness of pressure plate: 5.5 mm, sliding area: 50 cm²). Results of the measurement are shown in FIG. 1. Moreover, results of in-vehicle feeling sensory test are shown in Table 2.

TABLE 2

| | | | | | Comparative | Comparative |
|---|---|---|---|---|---|---|
| | | Example 1 | Example 2 | Example 3 | Example 1 | Example 2 |
| in-vehicle | (sensory | small pedal | good | large pedal | large pedal | small pedal |
| feeling | evaluation) | stroke | | stroke | stroke (out | stroke |
| | | (within | | (within | of allowable | (allowable |
| | | allowable | | allowable | range) | range) |
| | | range) | | range) | | |

As shown in FIG. 1, by adding the partially graphitized coke in a ratio of 0.5 to 2.5 vol %, friction materials each having compression deformation within allowable range could be produced. Moreover, as shown in Table 2, Examples 1 to 3 each having compression deformation within allowable range also afforded results that fall within allowable range.

As above, the friction materials obtained by utilization of the invention are friction materials having an appropriate compression deformation. Thus, it was possible to obtain a good pedal feeling property.

Since the invention can provide a friction material excellent in pedal feeling property, the material can be used in various kinds of vehicles and hence is industrially very valuable.

It will be apparent to those skilled in the art that various modifications and variations can be made to the described exemplary embodiments of the present invention without departing from the spirit or scope of the invention. Thus, it is intended that the present invention cover all modifications and variations of this invention consistent with the scope of the appended claims and their equivalents.

What is claimed is:

1. A non-asbestos friction material comprising:
a fibrous base material;
a friction modifier;
a binder; and
a partially graphitized coke which is blended in a ratio of 0.5 vol % to 2.5 vol %.

2. The non-asbestos friction material according to claim 1, wherein a compressibility ratio of the partially graphitized coke at a load of 900 MPa is less than 80%, and a recovery ratio when the load is removed is more than 30%.
